(19) United States
(12) Patent Application Publication
(10) Pub. No.: US 2011/0019097 A1
(43) Pub. Date: Jan. 27, 2011

(54) Video pattern generating device

(75) Inventor: David Hsu, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: C&C TECHNIC TAIWAN CO., LTD., Taipei Hsien (TW)

(21) Appl. No.: 12/458,863

(22) Filed: Jul. 24, 2009

(51) Int. Cl. H04N 5/00

(52) U.S. Cl. 348/608; 348/E05.001

(57) ABSTRACT

A video pattern generating device includes a housing, a set of buttons mounted on the housing, a display mounted on the housing, and a circuit board consisting of a keyboard circuit, a control circuit, a display circuit, a video pattern generating circuit, an video pattern encoder circuit, an output port, a power circuit and an image amplifier circuit and mounted in the housing and controllable by the buttons to generate video pattern signals and to encode video pattern signals for outputting to an external video output device for horizontal, vertical and pattern field inspection and correction.

### BACKGROUND OF THE INVENTION

1. Field of the Invention

The present invention relates to video pattern generating technology and more particularly, to a video pattern generating device for connection to a monitor, TV, projector or any other video output device to generate video image correction patterns, facilitating inspection and correction of video output of the video output device.

2. Description of the Related Art

When inspecting or correcting the video signal of a monitor, TV, projector or any other video output device, a big-scale video pattern generating apparatus shall be used and connected to the video output device to generate video patterns for inspection and correction. A conventional video pattern generating apparatus for this purpose is heavy and expensive, not convenient to carry. This type of video pattern generating apparatus is designed for use in a factory, not suitable for video output device distributors.

Further, a modern building generally has different cables embedded therein. There are no suitable inspection apparatus for inspecting normal conduction of the embedded cables of a newly established building. After finish of the construction of a building, the embedded cables may be unable to transmit signals.

Accordingly, there is a need for a video pattern generating device that eliminates the aforesaid problems.

### SUMMARY OF THE INVENTION

The present invention has been accomplished under the circumstances in view. It is one object of the present invention to provide a video pattern generating device, which facilitates video signal inspection and correction of a monitor, TV, projector or any other video output device. It is another object of the present invention to provide a video pattern generating device, which is inexpensive and convenient to carry.

To achieve these and other objects of the present invention, a video pattern generating device comprises a housing, a set of buttons mounted on the housing, a display mounted on the housing, and a circuit board mounted in the housing and controllable by the buttons to generate video pattern signals and to encode video pattern signals for outputting to an external video output device for horizontal, vertical and pattern field inspection and correction.

The video pattern generating device further comprises an image analyzer electrically connected to a signal connector of the circuit board by a cable to be examined, comprising a video decoder, an image analysis unit, an image resizer and a microprocessor. The image analyzer is adapted for displaying and analyzing high resolution multimedia interface, digital video interface, VGA (video graphics array) front and component video connector.

### BRIEF DESCRIPTION OF THE DRAWINGS

FIG. 1 is an elevational view of a video pattern generating device in accordance with the present invention.

FIG. 2 is an exploded view of the video pattern generating device in accordance with the present invention.

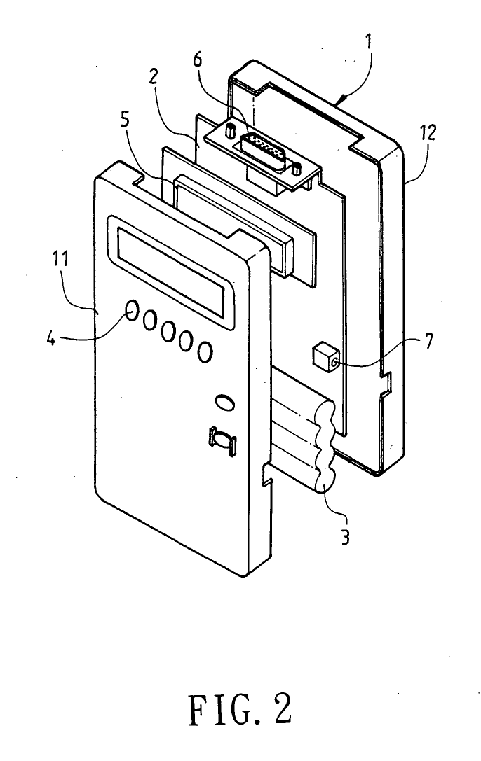

FIG. 3 is a circuit block diagram of the video pattern generating device in accordance with the present invention.

FIG. 4 is a schematic drawing showing an application example of the present invention.

FIG. 5 is an elevational view of an image analyzer in accordance with the present invention.

FIG. 6 is a circuit block diagram of the image analyzer in accordance with the present invention.

### DETAILED DESCRIPTION OF THE PREFERRED EMBODIMENT

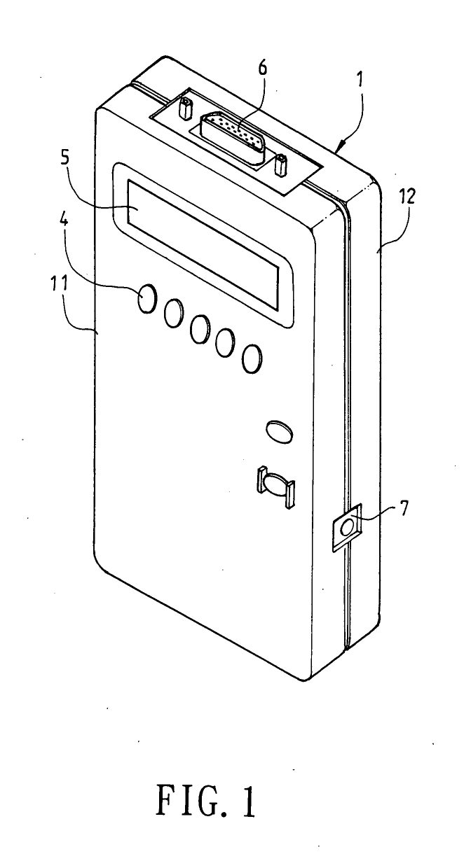

Referring to FIGS. 1˜3, a video pattern generating device is shown comprising a housing 1 formed of a top cover 11 and a bottom cover 12, a circuit board 2 mounted inside the housing 1, a battery pack 3 mounted inside the housing 1 and electrically connected to the circuit board 2, a set of buttons 4 electrically connected to the circuit board 2 and respectively extended out of the top cover 11 of the housing 1, a display screen 5 mounted in the top cover 11 of the housing 1 for viewing by a user and electrically connected to the circuit board 2, a signal connector 6 fastened to one end of the housing 1 and electrically connected to the circuit board 2, and a power jack 7 fastened to one lateral side of the housing 1 and electrically connected to the circuit board 2.

The circuit board 2 comprises a keyboard circuit 21 electrically connected to the buttons 4 and adapted for generating signals subject to operation of the buttons 4, a control circuit 22 adapted for receiving signals from the keyboard circuit 21 and processing signals through an algorithm and logic judgment processing process, a display circuit 23 electrically connected to the display screen 5 adapted for receiving signals from the control circuit 22 for display on the display screen 5, a video pattern generating circuit 24 controllable by the control circuit 22 to generate video pattern signal, an output port 26 for signal output, an video pattern encoder circuit 25 adapted for receiving video pattern signal from the video pattern generating circuit 24 and converting video pattern signal into a predetermined format for output through the output port 26 to the signal connector 6 for transmission to an external device, a power circuit 27 adapted for scanning power supply from the power jack 7 or battery pack 3 and switching to an external power supply loop to charge the battery pack 3 when power supply comes from the power jack 7 or disconnecting the external power supply loop when power supply comes from the battery pack 3, and an image amplifier circuit 28 adapted for amplifying voltage and current of signal from the video pattern encoder circuit 25 to maintain image quality before sending through the output port 26 to the signal connector 6.

During application, the video pattern generating device is connected to a video monitor, LCD TV or video projector either by a cable or wirelessly. A user can operate the buttons 4 to generate video pattern signals, which are encoded and then transmitted to a video output device for inspecting and correction of Horizontal, Vertical and Field. Thus, the invention facilitates video inspection and correction of video output devices.

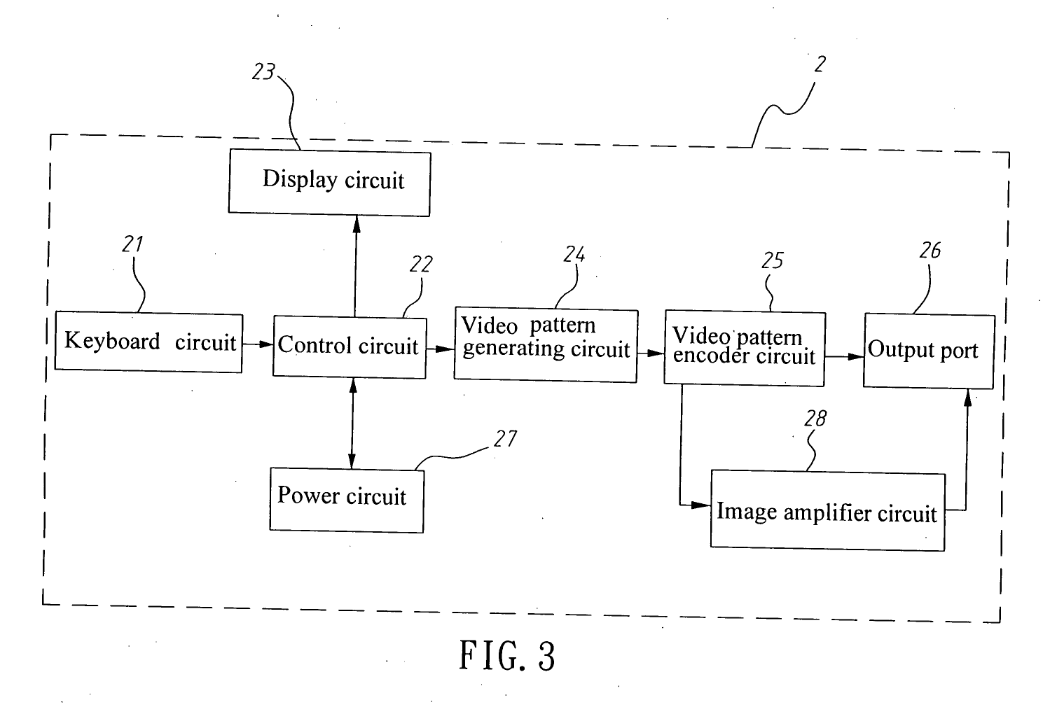

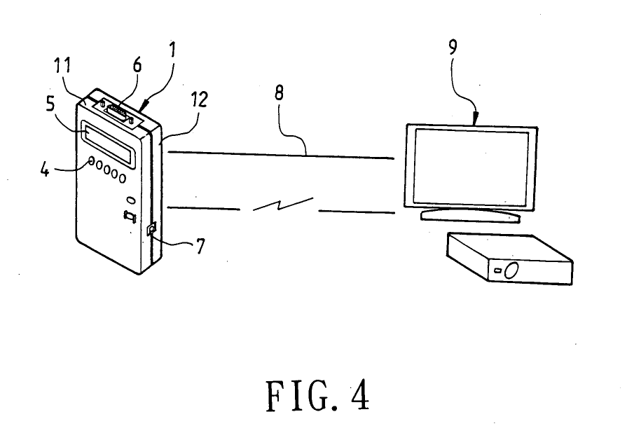

Referring to FIG. 4 and FIG. 3 again, when using the video pattern generating device, connect the signal connector 6 of the housing 1 to the video output device (monitor, TV or projector) 9 by a cable 8, and then operate the buttons 4 to drive the keyboard circuit 21 to send a corresponding signal to the control circuit 22 for processing through an algorithm and logic judgment processing process. At this time, the control circuit 22 provides an indication signal to the display circuit 23 for display on the display screen 5, and outputs the processed signal to the video pattern generating circuit 24, causing the video pattern generating circuit 24 to generate a corresponding video pattern signal for converting into a predetermined format by the video pattern encoder circuit 25 for output through the output port 26 to the video output device 9 via the cable 8 for Horizontal, Vertical and Pattern Field inspection and correction.

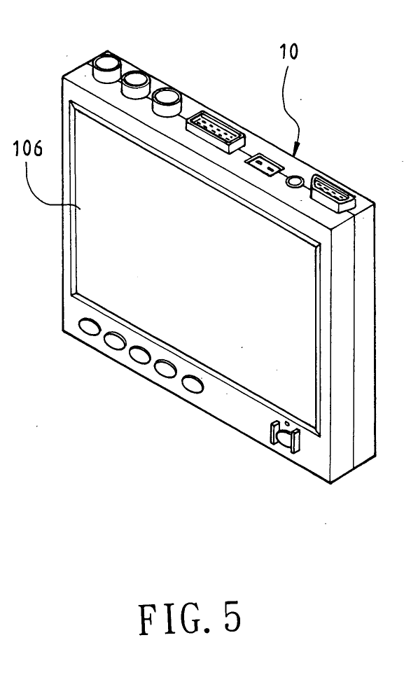

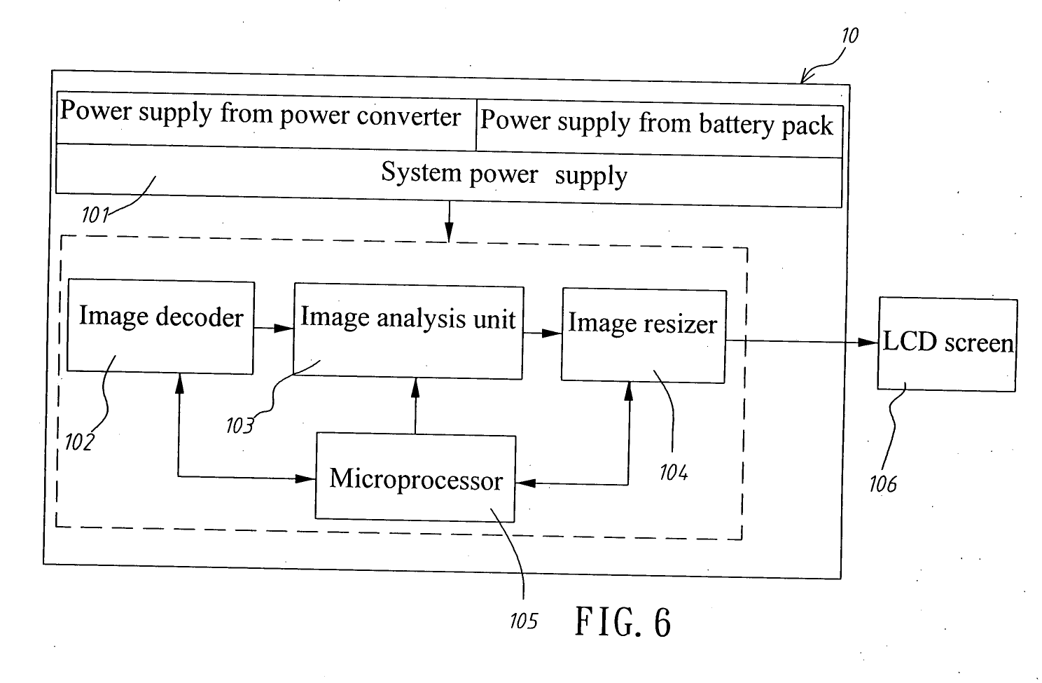

Referring to FIGS. 5 and 6, the invention further comprises an image analyzer 10. Subject to hardware architecture, the image analyzer 10 comprises a power supply board block diagram and an image processor board block diagram. The system power supply 101 of the power supply board block diagram can be obtained from an external power converter or an internal battery pack. The system uses power supply from the external power converter in priority. When the external power converter failed, the system switches to the internal battery pack.

The image processor board block diagram comprises a video decoder 102, an image analysis unit 103, an image resizer 104 and a microprocessor 105. The image analyzer 10 is adapted for displaying and analyzing (1) high resolution multimedia interface, (2) digital video interface, (3) VGA (video graphics array) front and (4) component video connector. Input video is decoded by the video decoder 102 into digital video format, and then analyzed by the image analysis unit 103 to obtain horizontal, vertical and field pattern data for resizing by the image resizer 104 to convert input video into LCD screen supportable resolution for display on a LCD screen 106.

The user can connect the image analyzer 10 to the other end of the cable 8 for enabling the image analyzer 10 to display horizontal, vertical and pattern field video data on the LCD screen subject to selection through a menu on the LCD screen 106.

In conclusion, the invention provides an inexpensive mobile video pattern generating device for connection to a monitor, TV, projector or any other video output device to facilitate video pattern inspection and correction.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A video pattern generating device, comprising:
a housing;
a set of buttons mounted on said housing;
a display mounted on said housing; and
a circuit board mounted in said housing and controllable by said buttons to generate video pattern signals and to encode said video pattern signals for outputting to an external video output device for horizontal, vertical and pattern field inspection and correction.

2. The video pattern generating device as claimed in claim 1, wherein said circuit board comprises:
a keyboard circuit electrically connected to said buttons and adapted for generating signals subject to control of said buttons;
a control circuit adapted for receiving signals from said keyboard circuit and processing signals through an algorithm and logic judgment processing process;
a display circuit electrically connected to said display screen adapted for receiving signals from said control circuit for display on said display screen;
a video pattern generating circuit controllable by said control circuit to generate video pattern signals;
a video pattern encoder circuit adapted for receiving video pattern signals from said video pattern generating circuit and converting video pattern signals into a predetermined format for output to an external video output device; and
an image amplifier circuit adapted for amplifying voltage and current of output signals from said video pattern encoder circuit to maintain image quality before sending to an external video output device.

3. The video pattern generating device as claimed in claim 2, wherein said circuit board further comprises a power circuit adapted to obtain the necessary working voltage for said circuit board selectively from an external power source and an internal battery pack thereof.

4. The video pattern generating device as claimed in claim 2, further comprising a signal connector mounted in said housing and electrically connected to said circuit board for output of encoded video pattern signal to an external video output device.

5. A video pattern generating device, comprising:
a housing;
a set of buttons mounted on said housing;
a display mounted on said housing; and
a circuit board mounted in said housing and controllable by said buttons to generate a video pattern signal and to encode said video pattern signal for outputting to an external video output device through a signal connector thereof for horizontal, vertical and pattern field inspection and correction; and
an image analyzer electrically connectable to said signal connector by a cable for examining said cable, said image analyzer comprising a video decoder for decoding video signals received from said signal connector, an image analysis unit adapted for displaying and analyzing high resolution multimedia interface, digital video interface, VGA (video graphics array) front and component video connector, a video resizer adapted for converting output signals from said image analysis unit into LCD screen supportable resolution, a microprocessor, and a LCD screen for displaying video data outputted from said video resizer.
